(19) United States
(12) Patent Application Publication
(10) Pub. No.: US 2009/0064926 A1
(43) Pub. Date: Mar. 12, 2009

(54) Drum for coating grained substrates

(76) Inventors: Reinhard Nowak, Binzen (DE); Norbert Zerrer, Schopfheim (DE); Guenther Boos, Bad Saeckingen (DE)

Correspondence Address: JACOBSON HOLMAN PLLC, 400 SEVENTH STREET N.W., SUITE 600, WASHINGTON, DC, 20004, US

(21) Appl. No.: 11/918,879

(22) PCT Filed: Apr. 21, 2006
(86) PCT No.: PCT/DE2006/000744

§ 371 Date: Nov. 19, 2008

(30) Foreign Application Priority Data
Apr. 21, 2005 (DE) 10 2005 019 443.5

(51) Int. Cl. B05C 1/08

(52) U.S. Cl. 118/258

(57) ABSTRACT

The invention concerns a drum for coating or drying grained substrates (10), said drum comprising a horizontal or slightly inclined axis (1). The invention is characterized in that the casing (2) of the drum comprises slots (5) for allowing through gas, said slots being formed between parallel ridges (8), said ridges (8) arranged inside the casing (2) of the drum sloping relative to the axis (1) and to the horizontal, such that the grained substrates (10), during rotation of the drum, are moved outwards of the drum into the discharge outlet zone. The geometrical cross-section of the ridges (8) is of any particular shape.

### TECHNICAL FIELD

The invention concerns a drum for coating or drying grained substrates. Drums of this type are also known in practice as drum coaters and are used, inter alia, in the pharmaceutical industry for the production, i.e. coating or drying, of pharmaceutical substrates in pill or tablet form. In a corresponding way, a multiplicity of substrates can also be produced for industrial purposes in the food industry by using drum coaters. The drums rotate about a horizontal or slightly inclined axis and have, at least partially, gas passages in the casing of the drum. A drying gas can be directed through the substrate from the outside inward, or vice versa, through the gas passages, preferably in the region of the circulating substrate, in order that moisture is dissipated from the surface of the individual elements of the substrate. The gas passages are formed in practice by screens or perforations, the size of the perforations being chosen to correspond to the size of the substrate, i.e. the individual gas passage is smaller than the smallest individual element of the circulating substrate.

### PRIOR ART

According to the prior art, the drums have at least one gas-permeable region, which is generally located in a central cylindrical portion of the drum. One side of the drum is usually closed in a conical form, while the other side takes the form of a frustum of a cone. In this case, the smaller circular area of the frustum of the cone is open, so that the drum can be filled or discharged through this opening.

EP 0 362 888 B1 describes, for example, a device for coating powdered or grained substances which has a drum that is rotatable about a horizontal axis. A gas can be passed through a central, cylindrical main body, both from the inside outward and from the outside inward, for which purpose most of the circumferential surface of the main body has a perforation.

The perforation is generally produced in practice by punching or drilling, creating in the wall of the drum small cylindrical holes that have very sharp edges toward the surface of the drum casing. In the case of sensitive substrates, the edges must be rounded by a separate grinding operation. Nevertheless, the large number of edges on the perforation remain and the substrates at least partially come into contact with this large number of edges during the circulating process. This can easily lead to the surface of the substrate becoming damaged, in particular in the case of sensitive substrates, for example with a still soft coating.

DD 122 106 discloses an electroplating drum, the casing of which comprises a multiplicity of round or tubular rod elements that are mounted parallel to the axis of rotation in the apertures of two opposite delimiting plates. In this case, the delimiting plates have edges that are extremely troublesome for coating and drying processes, which can damage the substrate.

In particular in the pharmaceutical industry, it is necessary for the devices or parts of devices that come into contact with the substrate to undergo thorough cleaning at regular or periodic intervals. This also includes the sometimes very small cylindrical holes of the perforation in the drum casing. Even small roughnesses of the walls of the holes can lead to considerable problems. In the same way, all the internals in the drums, such as the two delimiting plates for mounting the round or tubular rod elements, can only be cleaned with great effort.

### SUMMARY OF THE INVENTION

The invention is consequently based on the object of providing a drum for coating or drying grained substrates with which the substrate is effectively and gently circulated during the treatment and which can be easily cleaned.

The invention achieves the object by the features specified in claim 1. Advantageous developments of the invention are characterized in the subclaims and are described in more detail below together with the description of the preferred embodiment of the invention, including the drawing.

With the invention, the disadvantageous edges, disadvantageous in particular in the pharmaceutical industry, on the great multiplicity of perforations in the drum wall and on the internals according to the prior art are overcome and replaced by relatively few slots between parallel ridges. The ridges have no significant edges or there are no edges present, for example in the case of round rods. Of the parallel ridges, at least some are inclined with respect to the axis of the drum and the horizontal in such a way that, at least in the region of the discharge opening, during the treatment, i.e. during the rotation of the drum, the gravitational force causes the grained substrates to be moved away from the discharge opening within the depressions between the respective ridges.

The individual elements of the circulating substrate only slip or roll along on the rounded portions of the ridges, without coming into contact with an edge. In an advantageous way, this has the result that the contact of the substrates with the ridges is restricted to a point or a line. The circulation takes place extremely gently, with the consequence of very little abrasion.

The ridges, which according to the invention are inclined with respect to the axis of the drum and the horizontal, have the effect that the gravitational force that inevitably acts on the circulating substrate causes the circulating substrate in the pronounced depressions between the individual ridges to be moved laterally downward in a way corresponding to the direction of the depressions. With respect to the feature according to the invention that the ridges are also inclined with respect to the horizontal, it is also possible to incline the axis of the drum with respect to the horizontal. In this case too, the gravitational force causes the circulating substrate to be moved laterally downward, in a way corresponding to the direction of the depressions.

If, according to claim 2, some of the ridges are inclined in one direction and an equal number are inclined in the other direction with respect to the axis of the drum, a very advantageous axial circulation of the substrate toward or away from the centre of the drum is obtained along with the basic tangential circulation of the substrate. This form of the drum leads to particularly effective and gentle circulation of the substrates.

According to the invention, the wall of the drum does not have any holes or other difficult-to-access constrictions, as a result of which the entire drum, including the slots, can be cleaned without any problem.

The geometric form of the cross section of the ridges is not defined, but can be freely chosen. A simple round cross section is advantageous. To increase the stability of the drum as a whole, the ridges may also have a greater extent in the radial direction, i.e. have an oval cross section or a cross section with a shallow curvature with respect to the axis of the drum and a strong outer curvature.

According to claim 4, the ridges may also be formed in their longitudinal extent in a sinusoidal or other manner, for example be shaped in the manner of a meander. In this case, the orthogonal distance between two ridges is the same in each case.

The arrangement of the ridges according to the invention may also be combined in a way corresponding to claim 7 with the specific form of the drum. In this case, the drum casing has, at least in the region in which the ridges are arranged, the geometric form of a frustum of a cone. In this case, the gravitational force causes the circulating substrate to be moved in an axial direction in the depressions between the ridges and, in a corresponding way, in the same or the opposite other axial direction within the lateral area of the cone. A corresponding effect can also be achieved by the inclination of the drum axis.

With forms of the drum of this type it is possible to dispense with the blades, baffles and the like that forcibly circulate the substrate and are usually necessary in the prior art. This leads as a consequence to the further reduction of edge-induced loads on the circulating substrate, which may have damaging effects on the individual elements of the substrate.

The ridges may be produced within the drum casing by means of any desired technical methods. The ridges may be joined together in the form of independent semifinished parts with sheet-like semifinished metal parts, for example by welding, to form a drum casing according to the invention. However, the ridges may also be machined into a sheet-like semifinished metal part by a material-removing method.

In particular in the case of relatively large drums, it may be necessary for the purpose of ensuring adequate stability to provide static reinforcing elements between individual regions of gas passages. These may be solid, closed, annular portions in the drum casing, actual reinforcing elements or else stabilizing elements that extend over a surface area, are applied to the outside of the drum casing and cover over the region of the ridges, for example a screen mesh.

The inclined arrangement of the ridges with respect to the axis of the drum and the use of a drum with the geometric form of a frustum of a cone or an inclination of the axis of rotation of the drum can also be used in an advantageous way for the expulsion of the finished substrate from the drum. If the drum is rotated in such a way that the effect of the inclined ridges and that of the conical casing or the inclination of the drum cancel one another out, the substrate is axially circulated in an advantageous way without the substrate as a whole changing its axial position. If the rotational direction of the drum is changed, however, so that the effect of the inclined ridges and that of the conical casing or the inclination of the drum complement one another, the circulating substrate is only moved in one direction, in which an outlet opening may be provided.

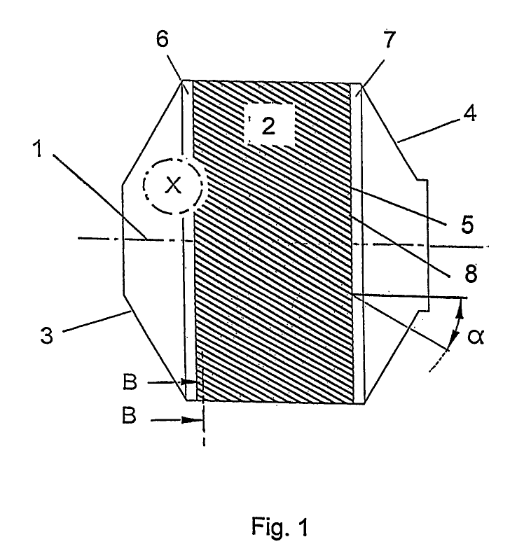

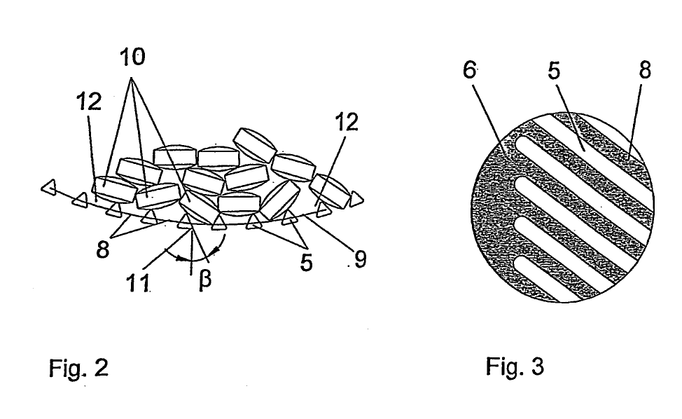

The invention is explained in more detail below on the basis of an exemplary embodiment. In association with this, FIG. 1 shows a schematic side view. FIGS. 2 and 3 show details of the drum according to the invention.

### EXEMPLARY EMBODIMENT

FIG. 1 shows a schematic side view of a drum according to the invention, which rotates during operation about an axis 1. The drum substantially comprises a drum casing 2, a closed conical base 3 and a central open conical charging portion 4.

The drum casing 2 is cylindrically formed and has ridges 8, between which slots 5 are formed as gas passages. The slots 5 are inclined in the horizontal plane with respect to the axis 1 by an angle α of 45° and are cut into a cylindrical drum sheet by a plasma cutting method in such a way that cylindrical collars 6 and 7 are formed on both sides in the drum casing 2. During production, the parameters of the plasma jet are set in such a way that the ridges 8 have well cut-off edges.

The cross section of the ridges 8 in FIG. 2, the section B-B in FIG. 1, and FIG. 3, and the detail X in FIG. 1 are shown enlarged. In the example, the plasma jet is pivoted by an angle β of 10° about the point 11 on a circular line 9 of the cylindrical drum casing 2. As a consequence, the ridges 8 have the cross section of a triangle with well rounded edges. The position of the slots 5, inclined with respect to the axis 1 by 45°, leads to inclined linear depressions 12, in which the gravitational force during rotation of the drum causes the substrates 10 to be moved downward in the falling direction of the depressions 12. In practice, the drum casing may also have regions of the same size with oppositely aligned slots. As a result, in addition to the radially tangential circulation brought about by the rotation of the drum, the substrates are also uniformly circulated in the axial direction.

1. A drum for coating or drying grained substrates (10), which is mounted rotatably in a horizontal slightly inclined axis (1) and has, at least partially, gas passages in the drum casing (2) and in the region of the substrate (10) circulating about the axis (1), characterized in that slots (5) that are formed between mutually parallel ridges (8) are present in the drum casing (2) as gas passages, at least some of the ridges (8) being inclined with respect to the axis (1) and the horizontal in such a way that, during the rotation of the drum, the gravitational force causes the grained substrates (10) to be moved laterally within the depressions (12) respectively between two ridges (8).

2. The drum as claimed in claim 1, characterized in that some of the ridges are inclined with respect to the drum axis in one direction and at least some of the other ridges are inclined in the opposite direction.

3. The drum as claimed in claim 1, characterized in that the ridges (8) are geometrically shaped in any way desired in cross section and in that the greatest distance between the adjacent ridges (8) is less than the smallest individual element of the circulating substrate (10).

4. The drum as claimed in claim 1, characterized in that the ridges are formed in the longitudinal direction in a manner other than rectilinear, in particular are shaped in a sinusoidal or other manner.

5. The drum as claimed in claim 1, characterized in that the ridges (8) are machined in the drum casing (2) by a material-removing method.

6. The drum as claimed in claim 1, characterized in that in the drum casing there are a number of mutually separate regions of gas passages, it being possible for static elements for reinforcing the drum to be provided between the individual regions.

7. The drum as claimed in claim 1, characterized in that, with a horizontal axis, the drum casing has, at least in the region in which the ridges are arranged, the geometric form of a frustum of a cone or in that the axis is inclined with respect to the horizontal.
